(19) United States
(12) Patent Application Publication
(10) Pub. No.: US 2012/0109827 A1
(43) Pub. Date: May 3, 2012

(54) Methods, Devices and Computer Program Products for Voucher Access Code Creation and Management

(76) Inventor: Per Otterström, Karlskrona (SE)

(21) Appl. No.: 13/382,400

(22) PCT Filed: Jul. 6, 2009
(86) PCT No.: PCT/SE09/50874

§ 371 Date: Jan. 5, 2012

(51) Int. Cl. G06F 21/00; G06Q 20/00

(52) U.S. Cl. 705/64; 705/26.1

(57) ABSTRACT

Methods, devices and computer program products are provided that provide refills for pre-paid subscriptions. A voucher activation code is received for a subscriber account. The voucher activation code is processed to obtain a voucher serial number, where the processing includes performance of a decryption operation. The voucher serial number is used to identify a voucher for use in updating the subscriber account.

### TECHNICAL FIELD

Embodiments described herein relate generally to voucher access codes, and more particularly, to creating and managing voucher access codes in communication systems.

### BACKGROUND

In telecommunications systems where pre-paid subscriptions are used, subscribers are able to refill their accounts with money. To refill an account, a subscriber may buy a voucher that contains a unique and secret code, often referred to as voucher activation code (VAC). The subscriber can provide the VAC to an account management system by, for example, directly typing the VAC into the subscriber's mobile phone using a specific format, which causes the VAC to be sent to the account management system as an unstructured supplementary service data (USSD) message, or the subscriber can call an interactive voice response (IVR) system where the subscriber may be instructed to type the VAC into the mobile phone.

The account management system keeps a digital copy of all vouchers in a voucher database. Each voucher is associated with a set of attributes in the database, such as a monetary value of the vouchers, expiration dates of the vouchers, etc. When a subscriber performs a refill, the VAC supplied by the subscriber is used to locate the voucher in the database. The value of the voucher is transferred to the subscriber account. Finally, the voucher is marked as used in the database to prevent the subscriber from using it again.

Each VAC includes a set of digits, enough to make it unlikely for a subscriber to guess a valid VAC by chance. At the time of voucher generation, VACs are typically created using random number generators. For administrative purposes, each voucher is also marked with a unique serial number. The serial number is not secret, but can only be used by operator personnel of the account management system to retrieve information about vouchers. The serial number cannot be used to perform a refill.

The VAC may also include a smaller portion of random digits, which are concatenated with the unique serial number. To make the smaller random portion less obvious, the position of some of the random digits may be swapped with the position of some of the digits of the serial number. For example, the first and fourth digits in the random portion can be swapped with the fifth and third digits in the serial number portion.

Vouchers, and their associated data, are stored in database tables. For swift access, database indexes are created for the VACs and for the serial numbers. The lifecycle of a voucher is usually very simple. When a voucher is loaded into the database, the voucher is directly available for usage, and is marked as used after a refill. However, sometimes other administrative states are used as well. For example, a voucher can be marked as damaged or stolen, and sometimes vouchers are loaded into the database, but are not marked as available for usage. To represent the different states of a voucher, depending on the database design, it may be necessary to use a set of other tables with at least one index each.

Voucher databases have some special characteristics compared to many other databases. Most importantly, voucher databases have to handle a fairly high number of insert and delete operations, compared to the number of read operations. Each time a voucher is inserted into, or deleted from, the database the indexes have to be updated to reflect the insertion/deletion. The process of updating database indexes tends to be a relatively expensive operation, performance-wise. Thus, as more and more vouchers are stored in the database, the price for maintaining the indexes increases, often exponentially, due to the fact that a smaller portion of the indexes can be kept in cache memories, and also due to the way hard disk drives operate. As a result, there is often a limit on how many vouchers can be stored simultaneously in the voucher database without sacrificing performance. Moreover, if used vouchers are not deleted from the database at the same pace as new vouchers are inserted, the response times eventually get too high and the throughput gets too low.

Malicious use of vouchers is a concern to voucher management systems. For example, malicious individuals may attempt to identify and mimic the VAC generator used by the operator, to obtain free refills. Obviously, the length of a VAC plays a part in how easy/difficult it will be for these malicious individuals to recreate serial numbers from VACs. When deciding on the length of the VACs to be used in a system, two major factors are typically considered. If each VAC includes a large number of digits, the system is more secure since it is harder to guess a valid VAC by chance. On the other hand, using too many digits for the VAC makes it inconvenient for subscribers (since the subscribers have to provide much longer VACs to redeem vouchers). Also, implementing VACs with large numbers of digits increases subscriber frustration with the system, since is it much more likely that subscribers will incorrectly provide the VACs. In such cases, the mistyped VACs may put a small, but significant, load on the system, thereby limiting the throughput of valid refills. Ultimately, this can have negative impact on the operator's revenue.

Some systems use random numbers for VACs. In these systems, the smallest acceptable number of digits in each VAC can be calculated as a function of the number of vouchers in the database and the amount of risk that is acceptable. As a simple example, assume that no more than 250,000,000 vouchers will be stored in the database simultaneously, and that it is considered as acceptable that every thousand random number is a valid VAC. In this example, the length of each VAC must be at least 12 digits.

The above considerations are also applicable to systems that use a smaller random part in combination with the unique serial number to create the VAC. In these types of systems, however, another problem arises. As described above, to make the small random part less obvious, it is possible to swap positions of some of the digits of the small random part with digits of the serial number part. However, if a subscriber buys two or more vouchers at the same time, the subscriber may likely have serial numbers in sequence, making it quite easy for an attentive subscriber to recognize the pattern. This issue becomes most obvious in the start of a serial number range.

The example below illustrates this issue. In this example, the first, second, and third random digits are swapped with the third, seventh, and fifth digits in the serial number, respectively. Once again, it is assumed that 250,000,000 vouchers will be stored, and that no more than every thousand number is a valid VAC. Assuming that the random part and serial number include the following digits, the VACs would be represented as follows:

| Random | Serial | VAC |
|---|---|---|
| 428 | 340000000 | 000344080200 |
| 961 | 340000001 | 000349010601. |

In this example, the pattern is quiet easily detected directly by the human eye because the serial number contains a large number of zeroes. This issue can be avoided, to some extent, if the random part is extended to contain more digits, perhaps as many as in the serial number itself. However, this results in the final VAC containing more digits than desired. In any case, a malicious individual, who attempts to find a pattern using a computer, may recognize the pattern for any serial number sequence, and any size of the random part.

### SUMMARY

It is an object of the invention to overcome at least some of the above disadvantages and to provide improved voucher access code creation and management.

Embodiments described herein may include systems and/or methods that allow for significantly improved performance and solve the problem caused by having a large number of vouchers in the voucher database. Vouchers are stored in the voucher database in a way that maximizes response time and throughput, even as the voucher database grows. In addition, embodiments described herein provide for VAC generation that makes it nearly impossible for malicious individuals to calculate valid VACs on their own.

Embodiments described herein allow for sequential disk access to the voucher database during voucher insertion and deletion, and when using vouchers or changing their state for other reasons. A sequential disk access pattern is ideal for two reasons. First, when data is to be read or written to a disk, the hard disk drive first seeks the correct position to read or write data. The seek operation may not be necessary if sequential disk access is used, since the disk will already be in the correct position since the previous disk operation. Second, if sequential disk access is used, the data block being read from or written to will often already be present in a cache memory, which is many times faster than the hard disk drive. This phenomenon is usually referred to as a “high cache hit rate.”

In an exemplary embodiment, a device may provide refills for pre-paid subscriptions. The device may receive a voucher activation code for a subscriber account. The device may further process the voucher activation code to obtain a voucher serial number, where the processing may include performance of a decryption operation. The device may also use the voucher serial number to identify a voucher for use in updating the subscriber account.

### BRIEF DESCRIPTION OF THE DRAWINGS

FIG. 1 is a diagram of an exemplary network in which systems and/or methods described herein may be implemented;

FIG. 2 is a diagram of an exemplary components of a voucher device of FIG. 1;

FIG. 3 is a diagram of exemplary functional components of the voucher device of FIG. 1;

FIG. 4 is a diagram of exemplary portion of a database that may be associated with the voucher device of FIG. 1;

FIG. 5 is a flowchart of an exemplary process for generating a VAC;

FIG. 6 is an example of the process described in FIG. 5;

FIG. 7 is a flowchart of an exemplary process for loading a batch of VACs into the database of FIG. 4;

FIG. 8A is a flowchart of an exemplary process for redeeming a voucher;

FIG. 8B is a flowchart of an exemplary process for interacting with the database of FIG. 4 when a subscriber update is successful;

FIG. 8C is a flowchart of an exemplary process for interacting with the database of FIG. 4 when a subscriber update is unsuccessful;

FIG. 9 is a flowchart of an exemplary process for processing a VAC to obtain a serial number; and

FIG. 10 is a flowchart of an exemplary process for deleting VACs from the database of FIG. 4.

### DETAILED DESCRIPTION

The following detailed description refers to the accompanying drawings. The same reference numbers in different drawings may identify the same or similar elements. Also, the following detailed description does not limit the invention.

Embodiments described herein provide an improved manner of managing vouchers and a manner of creating more secure VACs. In one embodiment, a voucher device sequentially inserts vouchers and voucher state changes into a voucher database, without using traditional indexes. As a result, sequential disk access may be used for voucher insertions and deletions, which yields a high cache hit rate and good performance. In addition, the voucher device may calculate a VAC for a voucher using the serial number with which the voucher is associated. For example, the voucher device may calculate a VAC by encrypting the serial number, using a private encryption key. In one embodiment, the voucher device may, to increase security, use a small random number (e.g., as an initialization vector) to obfuscate the serial number before the encryption process. The final VAC may have no obvious relation to the serial number, thereby reducing the ability of individuals to maliciously attempt to calculate the VAC for other serial numbers. This way, the VACs no longer need to be stored in the voucher database, making the need to create and maintain an index for the VACs unnecessary. By storing the serial numbers sequentially in the voucher database, there also is no need to maintain an index for the serial numbers. At the time of refill, when a subscriber supplies a VAC, the voucher device may locate the correct voucher by simply decrypting the VAC (and undoing the obfuscating operation using the small random number), and then looking up the voucher based on the serial number.

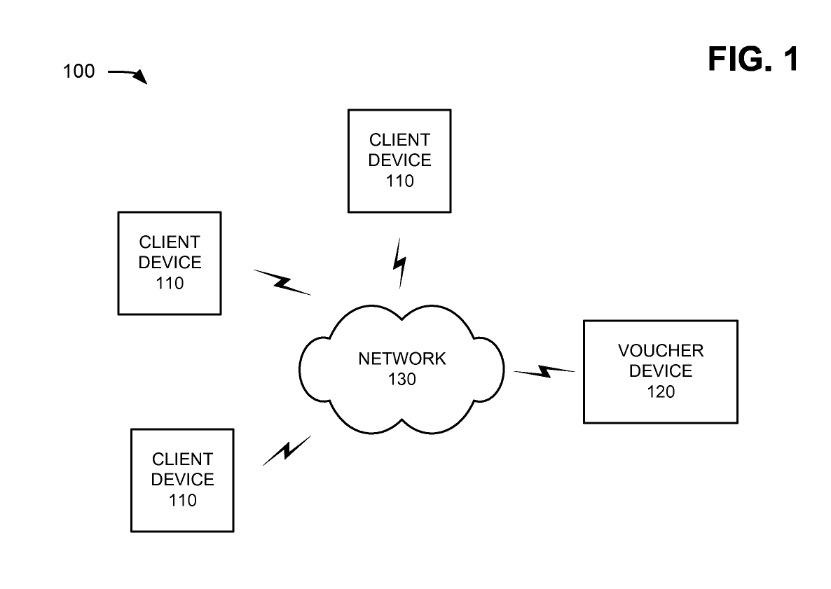

FIG. 1 is a diagram of an exemplary network 100 in which systems and/or methods described herein may be implemented. Network 100 may include client devices 110, a voucher device 120, and a network 130. Three client devices 110, a single voucher device 120, and a single network 130 have been illustrated for simplicity. In practice, there may be more or fewer client devices and more voucher devices and/or networks.

Client device 110 may include a device, such as a personal computer, a mainframe computer, a server, a lap top, a personal digital assistant (PDA), a telephone device, such as a wired or wireless telephone, etc., one or more threads or processes running on these devices or other types of devices, and/or one or more objects being executed by these devices or other types of devices. In one implementation, client device 110 may allow a subscriber to refill an account using a voucher. The account may correspond to any type of account where monetary values (or credits) are represented with sequence codes, such as, for example, in pre-paid telecommunications subscription systems, ticket booking systems, online gaming systems, etc. Client device 110 may connect to network 130 via any technique, such as wired or wireless connections.

Voucher device 120 may include one or more devices that manage VACs. For example, voucher device 120 may calculate VACs for vouchers, store information that allows for vouchers to be redeemed by subscribers, manage the storage of the information, and enable accounts to be refilled based on received VACs. Voucher device 120 may include one or more centrally located or distributed servers and/or other types of network devices. Voucher device 120 may connect to network 130 via any technique, such as wired or wireless connections.

Network 130 may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of network.

In some embodiments, one or more devices of network 100 may perform one or more of the tasks described as being performed by one or more other devices of network 100.

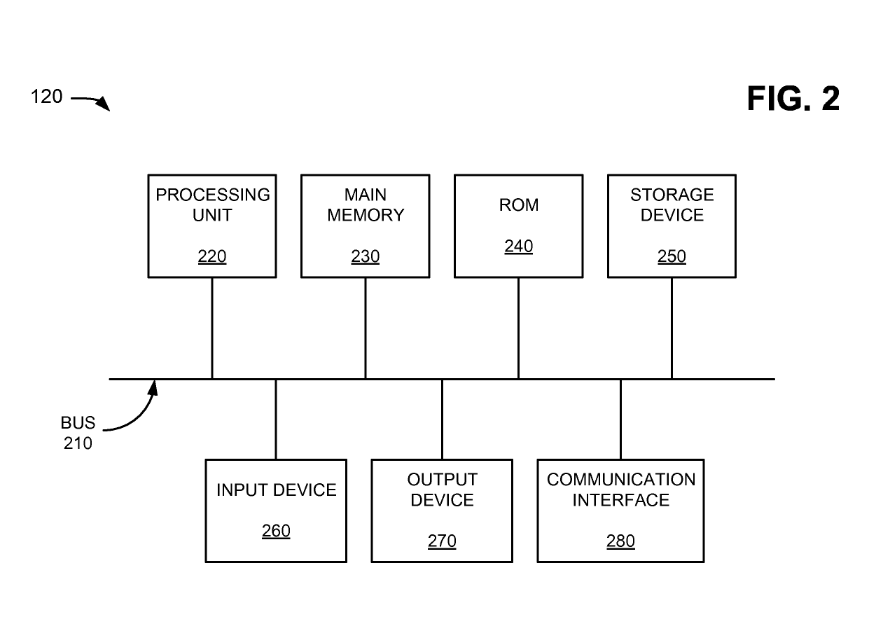

FIG. 2 is a diagram of exemplary components of voucher device 120. As illustrated, voucher device 120 may include a bus 210, a processing unit 220, a main memory 230, a read only memory (ROM) 240, a storage device 250, an input device 260, an output device 270, and a communications interface 280. The number of components illustrated in FIG. 2 is provided for simplicity. In practice, it will be appreciated that voucher device 120 may include more buses, processing units, memories, ROMs, storage devices, input devices, output devices, and communications interfaces that may be located on a single device or located on multiple, centrally located or distributed devices.

Bus 210 may permit communication among the components of voucher device 120. Processing unit 220 may include any type of processor or microprocessor that interprets and executes instructions. Additionally or alternatively, processing unit 220 may be implemented as or include an application specific integrated circuit (ASIC), a field programmable gate array (FPGA), or the like. Main memory 230 may include a random access memory (RAM) or another type of dynamic storage device that stores information and instructions for execution by processing unit 220. ROM 240 may include a ROM device and/or another type of static storage device that stores static information and instructions for processing unit 220. Storage device 250 may include a magnetic and/or optical recording medium and its corresponding drive, or a removable form of memory, such as a flash memory.

Input device 260 may include a mechanism that permits an operator to input information to voucher device 120, such as a keyboard, a mouse, a button, a pen, a touch screen, voice recognition and/or biometric mechanisms, etc. Output device 270 may include a mechanism that outputs information to the operator, including a display, a light emitting diode (LED), a speaker, etc. Communication interface 280 may include any transceiver-like mechanism that enables voucher device 120 to communicate with other devices and/or systems. For example, communication interface 280 may include mechanisms for communicating with another device or system via a network, such as network 130.

As will be described in detail below, voucher device 120 may perform certain processes relating to vouchers. Voucher device 120 may perform these and other processes in response to processing unit 220 executing software instructions contained in a computer-readable medium, such as main memory 230. A computer-readable medium may be defined as a logical or physical memory device. A logical memory device may include a space within a single physical memory device or spread across multiple physical memory devices.

The software instructions may be read into main memory 230 from another computer-readable medium, such as storage device 250, or from another device via communication interface 280. The software instructions contained in main memory 230 may cause processing unit 220 to perform processes that will be described later. Alternatively, hardwired circuitry may be used in place of or in combination with software instructions to implement processes described herein. Thus, systems and methods described herein are not limited to any specific combination of hardware circuitry and software.

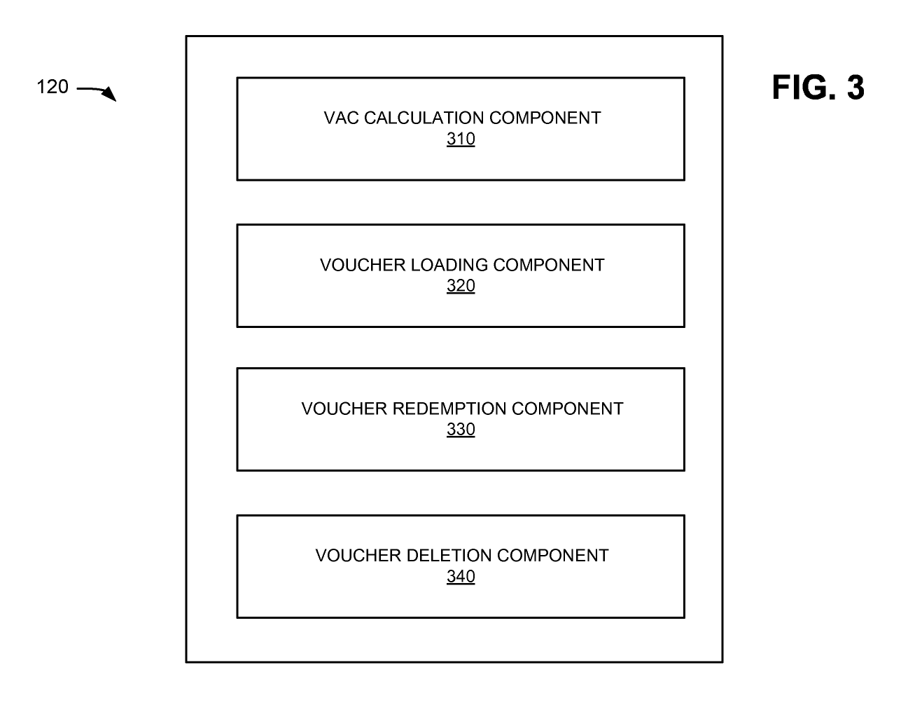

FIG. 3 is a diagram of exemplary functional components of voucher device 120. As illustrated, voucher device 120 may include a VAC calculation component 310, a voucher loading component 320, a voucher redemption component 330, and a voucher deletion component 340. VAC calculation component 310, voucher loading component 320, voucher redemption component 330, and voucher deletion component 340 may be implemented via a single device (e.g., a single server) or one or more different devices (e.g., different servers). In one embodiment, the functions described in connection with FIG. 3 may be performed by one or more of the components depicted in FIG. 2.

VAC calculation component 310 may include one or more components that calculate VACs for vouchers. The VAC calculation may include, for example, an obfuscation process and/or an encryption process. For example, VAC calculation component 310 may obfuscate a serial number for a voucher using an initialization vector to obtain an obfuscated serial number. The obfuscation process may include, for example, XORing the serial number with the initialization vector, bit swapping, and/or other techniques for making the serial number less detectable.

VAC calculation component 310 may encrypt the obfuscated serial number, using a private encryption key, to obtain the VAC for the voucher. When an initialization vector is used, VAC calculation component 310 may add the initialization vector to the encrypted number to form the final VAC. In one embodiment, VAC calculation component 310 may simply encrypt the serial number, using an encryption key, to obtain the VAC for the voucher, without first obfuscating the serial number. The encryption process may include a single encryption process or multiple encryption processes, where a different encryption key may be used for at least one of the encryption processes. The encryption process may include the user of a symmetric key algorithm (where the same key is used for encryption and decryption) or an asymmetric key algorithm (where different keys are used for encryption and decryption). An example of a symmetric key algorithm may include the Data Encryption Algorithm (DEA). An example of an asymmetric key algorithm may include the RSA algorithm.

Voucher loading component 320 may include one or more components that manage the storage of vouchers in a voucher database. In one embodiment, voucher loading component 320 may load vouchers into the voucher database in batches, where each batch may include, for example, a few hundred vouchers up to one million or more vouchers. Voucher loading component 320 may store vouchers in the voucher database in sequence, based on the serial numbers with which the vouchers are associated.

Voucher redemption component 330 may include one or more components that enable subscribers to redeem vouchers. For example, voucher redemption component 330 may receive, from a subscriber, a VAC of a voucher, process the received VAC to identify the serial number for the voucher, use the serial number to obtain information for refilling the subscriber's account, and enable the subscriber's account to be refilled based on the obtained information. Voucher redemption component 330 may further include one or more components that update the voucher database when a subscriber's account has been refilled using a voucher.

Voucher deletion component 340 may include one or more components that interact with the voucher database to delete vouchers. For example, voucher deletion component 340 may delete old vouchers from the voucher database, in response to a command from an operator of voucher device 120 or automatically at, for example, predetermined intervals. In one embodiment, voucher deletion component 340 may delete vouchers in batches.

The functional components illustrated in FIG. 3 are exemplary. In practice, voucher device 120 may include fewer, different, and/or additional functional components than illustrated in FIG. 3. In some embodiments, one or more functional components of voucher device 120 may perform one or more of the tasks described as being performed by one or more other functional components of voucher device 120.

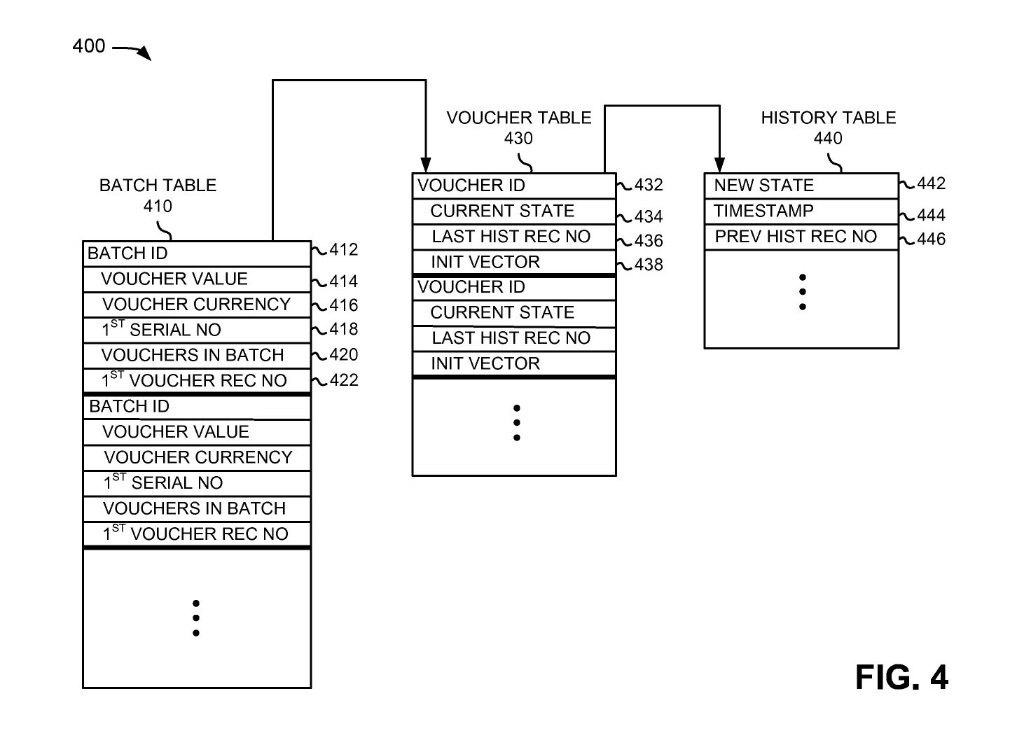

FIG. 4 is a diagram of an exemplary portion of a voucher database 400 that may be associated with voucher device 120. While one database is described below, it will be appreciated that voucher database 400 may include multiple databases stored locally at voucher device 120 (e.g., in main memory 230 and/or storage device 250), or stored at one or more different and possibly remote locations.

As illustrated, voucher database 400 may include the following exemplary group of tables: a batch table 410, a voucher table 430, and a history table 440. In some embodiments, voucher database 400 may include additional, fewer, or different tables than illustrated in FIG. 4. For example, in one embodiment, voucher database 400 may only include a voucher table 430 or may only include a batch table 410 and a voucher table 430.

Batch table 410 may store information relating to batches of vouchers. Each batch of vouchers may be associated with a group of sequential serial numbers that does not overlap with serial numbers in another batch of vouchers. Batch table 410 may, for example, include a batch identifier field 412. Batch identifier field 412 may store a sequence of characters that identifies a batch of vouchers. Batch table 410 may maintain a group of entries in the following exemplary fields for each particular batch identifier in batch identifier field 412: a voucher value field 414, a voucher currency field 416, a first serial number field 418, a vouchers in batch field 420, and a first voucher record number field 422. Batch table 410 may maintain additional, fewer, or different fields than illustrated in FIG. 4.

Voucher value field 414 may store a value (e.g., a monetary value) for the vouchers in the batch. In one embodiment, each voucher in a particular batch may be associated with the same value. The value may be a monetary value or another type of value, such as a particular number of credits. Voucher currency field 416 may store, when the value in voucher value field corresponds to a monetary value, information identifying the type of currency to which the monetary value corresponds. For example, voucher currency field 416 may store information identifying that the monetary value is stored in Euros, Dollars, Yens, etc.

First serial number field 418 may store information identifying the first serial number in the serial numbers associated with the vouchers in the particular batch. As indicated above, each batch may include a group of vouchers having serial numbers that are sequentially ordered. Thus, first serial number field 418 may store information identifying the first serial number in the sequential ordered group of vouchers. Vouchers in batch field 420 may store a value identifying a quantity of vouchers in the particular batch. First voucher record number field 422 may store information identifying a location of the first record (or row identifier) in voucher table 430 where the vouchers for the particular batch are stored. The information may be a pointer to the first record in voucher table 430 for the particular batch of vouchers.

By representing a batch of vouchers via a single record in batch table 410, batch table 410 may contain relatively few records and may, therefore, be small enough to fit in memory (e.g., main memory 230). In one embodiment, batch table 410 may be associated with an index, which spans serial number ranges, rather than individual serial numbers. Because of the limited size of this index, the index may be inexpensive to implement.

Voucher table 430 may store information relating to vouchers. For example, voucher table 430 may include a voucher identifier field 432. Vouch identifier field 432 may store a sequence of characters that identifies a particular voucher. In one embodiment, the sequence of characters may be unique for that particular voucher. The sequence of characters may, for example, correspond to the serial number of the particular voucher. Voucher table 430 may maintain a group of entries in the following exemplary fields for each particular voucher identifier in voucher identifier field 432: a current state field 434, a last history record number field 436, and an initialization vector field 438. Vector table 430 may maintain additional, fewer, or different fields than illustrated in FIG. 4.

Current state field 434 may store information identifying a current state of the particular voucher. For example, current state field 434 may store information indicating that the voucher is available (e.g., meaning that the voucher has not yet been redeemed by a subscriber), reserved (e.g., meaning that the voucher is in the process of being redeemed by the subscriber), used (e.g., meaning that the voucher has been redeemed by a subscriber), etc. Last history record number field 436 may store information identifying a location (e.g., a record number or row identifier) in history table 440 of the entry that corresponds to the particular voucher, indicating an activity that occurred in connection with the particular voucher. Initialization vector field 438 may store an initialization vector for the particular voucher. As indicated briefly above, the initialization vector may be used in connection with calculating the VAC for the voucher.

History table 440 may store information relating to activities performed on the vouchers in voucher table 430. For example, history table 440 may maintain a group of entries in the following exemplary fields: a new state field 442, a timestamp field 444, and a previous history record number field 446. History table 440 may maintain additional, fewer, or different fields than illustrated in FIG. 4.

New state field 442 may store information identifying a new state of a voucher, with which the record corresponds, in voucher table 430. For example, new state field 442 may indicate that the corresponding voucher is available, reserved, used, etc. Timestamp field 444 may store information identifying a date and/or time that the state of the corresponding voucher changed. Previous history record field 440 may store information identify a location (e.g., a record number or row identifier) for a previous record (if any) in history table 440 for the corresponding voucher.

In one embodiment, voucher table 430 and history table 440 may be implemented as queue tables (i.e., new entries may be appended to the end of the tables). In addition, whenever an entry is inserted into voucher table 430 or history table 440, the entry may receive a record number which is immutable (i.e., the record number stays the same through out its lifetime). If the record number is immutable, the record number may be ideal as a primary key when performing operations on those tables.

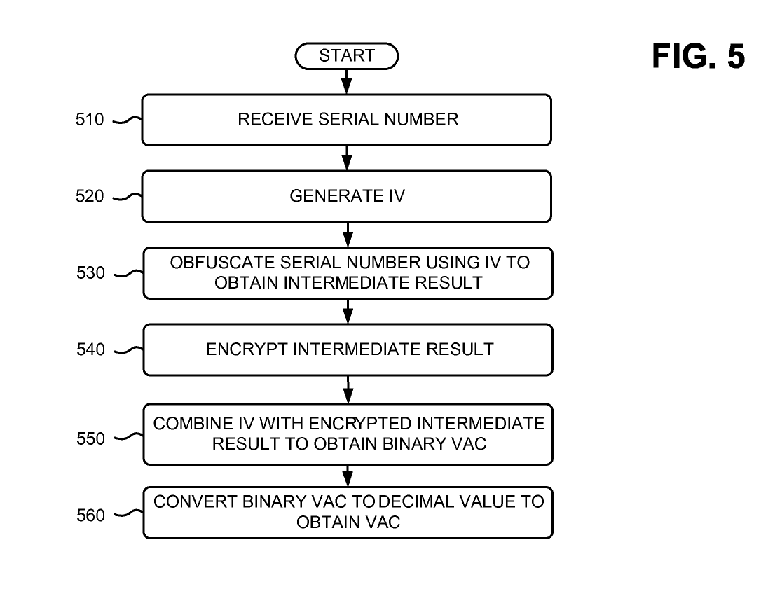

FIG. 5 is a flowchart of an exemplary process for generating a VAC. In one embodiment, the process described in FIG. 5 may be performed by voucher device 120 (e.g., by VAC calculation component 310). In another embodiment, some or all of the exemplary process described below may be performed by another device or combination of devices, including or excluding voucher device 120.

The exemplary process may begin with voucher device 120 receiving a serial number (block 510). In one embodiment, a network administrator (or other type of operator) may load one or a group of serial numbers into voucher device 120 for generating VACs. Voucher device 120 may generate an initialization vector (IV) (block 520). In one embodiment, voucher device 120 may generate the initialization vector using a random number generator. Other techniques for generating the initialization vector may alternatively be used.

Voucher device 120 may obfuscate the serial number using the initialization vector to obtain an intermediate result (block 530). In one embodiment, voucher device 120 may use any technique that makes the serial number less detectable. For example, voucher device 120 may XOR the initialization vector with the serial number to obtain an intermediate result, may bit swap bits in the initialization vector and the serial number to obtain an intermediate result, and/or may perform another technique or combination of techniques for obfuscating the serial number with the initialization vector.

Voucher device 120 may encrypt the intermediate result (block 540). For example, voucher device 120 may use a known encryption algorithm to encrypt the intermediate result, using an encryption key. For example, the encryption algorithm may include a symmetric key algorithm or an asymmetric key algorithm. In either situation, the encryption key or encryption and decryption keys may be a secret (or private) key. In one embodiment, voucher device 120 may not perform the obfuscation operation, but may simply encrypt the serial number.

Voucher device 120 may combine the initialization vector with the encrypted intermediate result to obtain a binary VAC (block 550). For example, voucher device 120 may append the initialization vector to the beginning of the encrypted intermediate result to obtain a binary VAC. Voucher device 120 may convert the binary VAC to a decimal value to obtain the VAC (block 560).

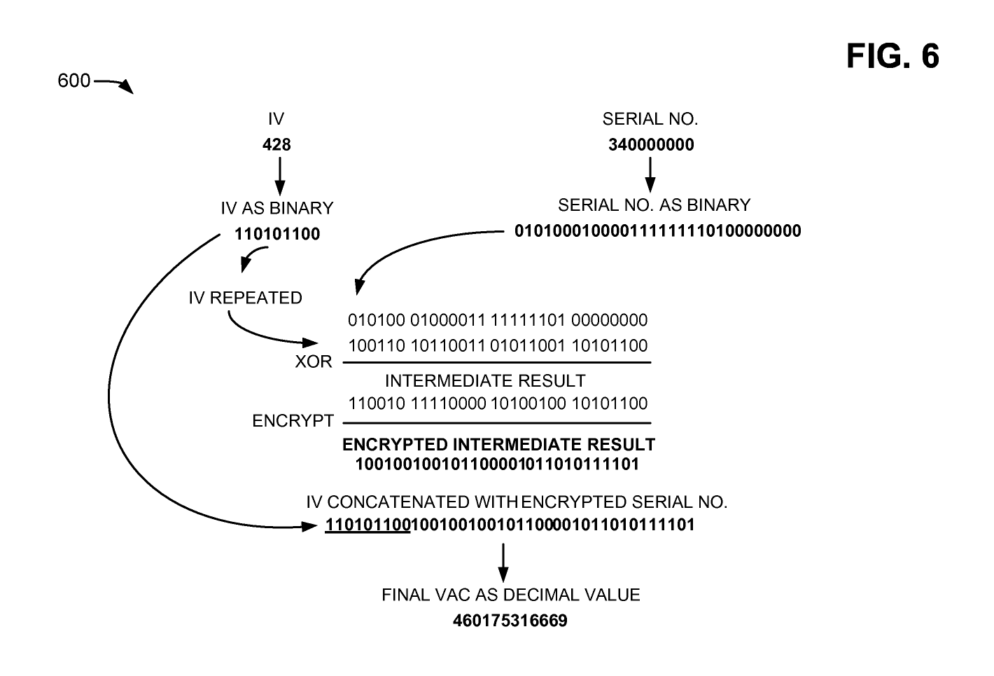

FIG. 6 is an example 600 of the process described above with respect to FIG. 5. In example 600, assume that voucher device 120 receives the serial number: 340000000. In addition, assume that voucher device 120 generates an initialization vector of 428 using, for example, a random number generator. Voucher device 120 may convert the initialization vector to a binary number (shown as 110101100 in FIG. 6) and the serial number to a binary number (shown as 010100010000111111110100000000 in FIG. 6). Voucher device 120 may XOR a repeated version of the binary initialization vector with the binary serial number to obtain the intermediate result: 110010 11110000 10100100 10101100. Assume further that voucher device 120 encrypts the intermediate result, using a private encryption key. Moreover, assume, for explanatory purposes only, that encryption of the intermediate result results in the encrypted intermediate result: 100100100101100001011010111101. Voucher device 120 may append the binary version of the initialization vector (110101100) to the beginning of the encrypted intermediate result to obtain a binary version of the VAC (shown as 110101100100100100101100001011010111101 in FIG. 6, where the underlining simply identifies the appended initialization vector in the binary version of the VAC). Voucher device 120 may then convert the binary version of the VAC to a decimal value to obtain the VAC, which is shown as 460175316669 in FIG. 6. The above technique produces a final VAC (i.e., 460175316669) that has no obvious relation to the serial number (i.e., 340000000) or the initialization vector (i.e., 428), making it impossible for malicious individuals to calculate valid VACs on their own.

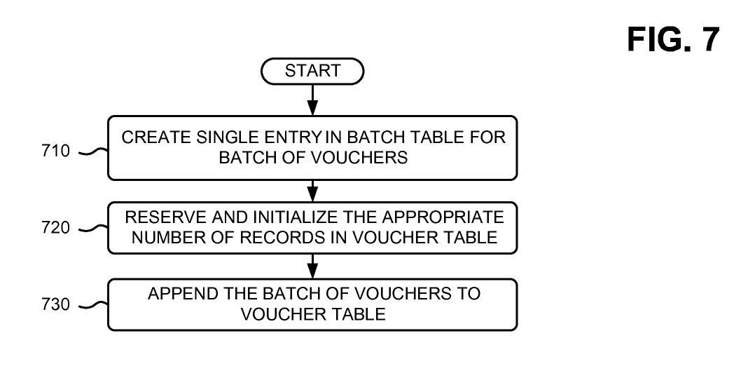

FIG. 7 is a flowchart of an exemplary process for loading a batch of VACs into voucher database 400 of FIG. 4. In one embodiment, the process described in FIG. 7 may be performed by voucher device 120 (e.g., by voucher loading component 320). In another embodiment, some or all of the exemplary process described below may be performed by another device or combination of devices, including or excluding voucher device 120.

The exemplary process may begin with voucher device 120 creating a single entry in batch table 410 for a batch of vouchers (block 710). In one embodiment, voucher device 120 may receive a batch of vouchers. Voucher device 120 may create an entry in batch table 410 for the batch of vouchers by, for example, storing an identifier for the batch in batch identifier field 412 of batch table 410. Voucher device 120 may populate other fields of batch table 410 for the batch of vouchers, such as voucher value field 412, voucher currency field 416, first serial number field 418, vouchers in batch field 420, and first voucher record number field 422.

Voucher device 120 may reserve and initialize the appropriate number of records in voucher table 430 (block 720). For example, voucher device 120 may reserve the number of records based on the number of serial numbers of the vouchers in the batch, where a separate record is reserved and initialized for each voucher serial number.

Voucher device 120 may append the batch of vouchers in voucher table 430 (block 730). In one embodiment, voucher device 120 may append the vouchers sequentially, based on serial numbers, to the end of voucher table 430.

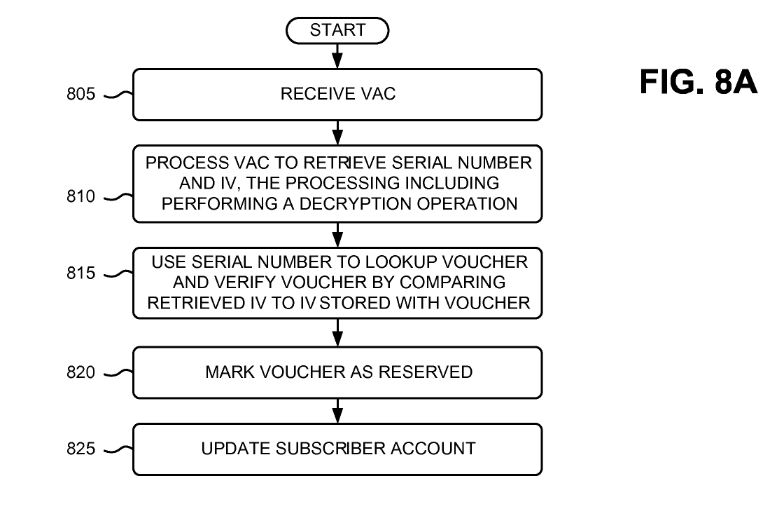

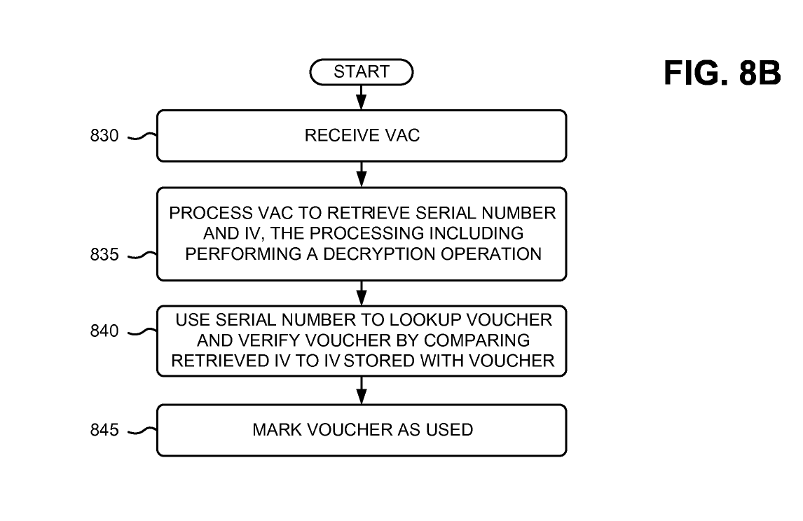

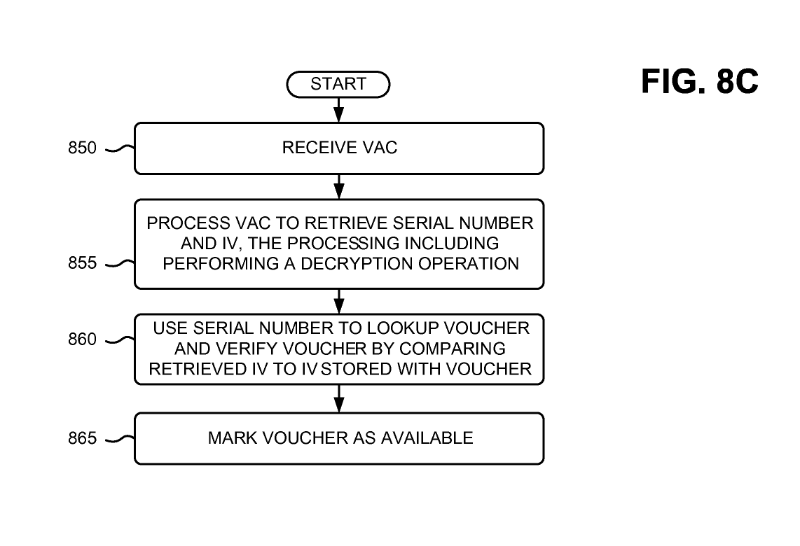

FIG. 8A is a flowchart of an exemplary process for redeeming a voucher. In one embodiment, the process described in FIG. 8A may be performed by voucher device 120 (e.g., by voucher redemption component 330). In another embodiment, some or all of the exemplary process described below may be performed by another device or combination of devices, including or excluding voucher device 120.

The exemplary process may begin with voucher device 120 receiving a VAC (block 805). For example, a subscriber may cause a client device 110 to connect to voucher device 120 via network 130. In one embodiment, the connection may, for example, be a telephone call or a network connection (e.g., a wired or wireless network connection). Once connected to voucher device 120, the subscriber may provide the VAC to voucher device 120. For example, the subscriber may provide the VAC, to voucher device 120, audibly, via a keyboard or keypad associated with client device 110, and/or in other ways. In one embodiment, voucher device 120 may receive the VAC as part of a USSD message.

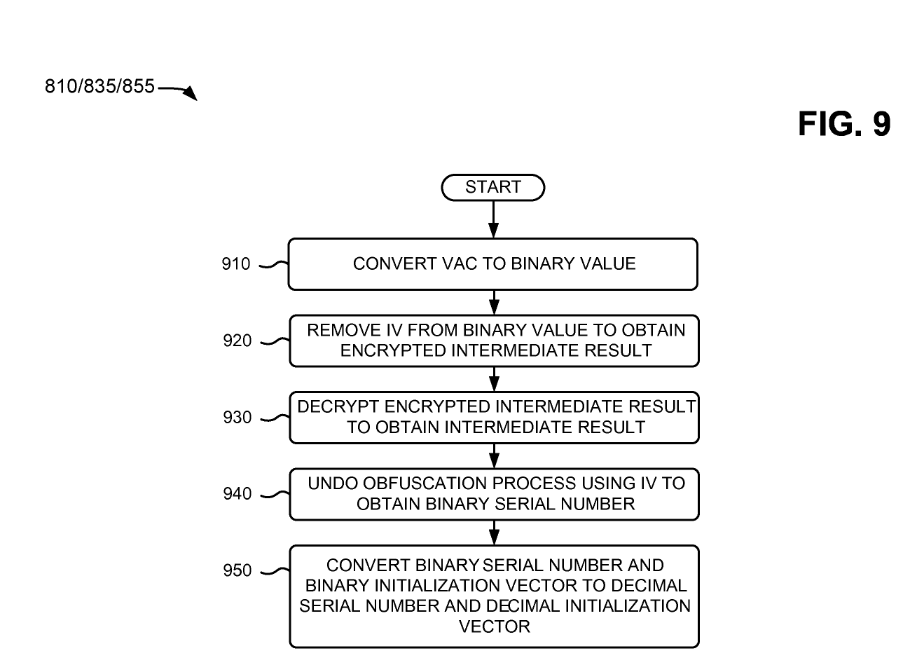

Voucher device 120 may process the VAC (e.g., using a decryption operation) to retrieve a serial number and an initialization vector (block 810). For example, voucher device 120 may perform a process similar to the process described above with respect to FIG. 5, but in the reverse order. An exemplary process for retrieving a serial number and an initialization vector from a received VAC is provided below with respect to FIG. 9. Another process may alternatively be used to recover a serial number from the received VAC.

Voucher device 120 may look up the voucher using the serial number (block 815). For example, voucher device 120 may use the serial number to look up the corresponding voucher in batch table 410 (e.g., by comparing the serial number to serial numbers in first serial number fields 418 of batch table 410). For example, voucher device 120 may calculate the offset, for the serial number, from the first voucher in the batch. Using the offset, voucher device 120 may identify the particular row in which the corresponding voucher is located in voucher table 430.

Once the appropriate row of voucher table 430 has been identified (i.e., the row that corresponds to the voucher being redeemed), voucher device 120 may verify the voucher using the initialization vector (block 815). For example, voucher device 120 may compare the initialization vector obtained from the VAC (also called a “received initialization vector”) to the initialization vector stored in initialization vector in field 438 of voucher table 430 (also called the “stored initialization vector”). If the received initialization vector does not match the stored initialization vector, voucher device 120 may, for example, end the redemption process and possibly alert the subscriber and/or system administrator that the voucher redemption has failed.

If the received initialization vector matches the stored initialization vector, voucher device 120 may mark the voucher as reserved (block 820). For example, voucher device 120 may change the state of the voucher in current state field 434 in voucher table 430 to “reserved.” In one embodiment, voucher device 120 may also add an entry in history table 440 that reflects the change in status of the voucher, the date and/or time that the change occurred, etc.

Voucher device 120 may enable an update of the subscriber's account (block 825). For example, voucher device 120 may send the appropriate monetary value or credits, associated with the voucher, to a device (e.g., a device that manages subscriber accounts), for updating the subscriber's account. Alternatively, voucher device 120 may update the subscriber's account with the appropriate monetary value or credits. For example, the update process may involve voucher device 120 accessing a subscriber database and updating an appropriate account field associated with the subscriber with the monetary value or credits.

FIG. 8B is a flowchart of an exemplary process for interacting with voucher database 400 of FIG. 4 when a subscriber update is successful. In one embodiment, the process described in FIG. 8B may be performed by voucher device 120 (e.g., by voucher redemption component 330). In another embodiment, some or all of the exemplary process described below may be performed by another device or combination of devices, including or excluding voucher device 120.

The exemplary process may begin with voucher device 120 receiving a VAC (block 830). For example, voucher device 120 may receive the VAC and an indication from the device that performed the subscriber account update of whether the update has succeeded. For this particular flowchart, assume that voucher device 120 receives an indication that the update was successful.

Voucher device 120 may process the VAC (e.g., using a decryption operation) to retrieve a serial number and an initialization vector (block 835). For example, voucher device 120 may process the VAC in a manner similar to the manner described above with respect to block 810 in FIG. 8A. At the end of the processing, voucher device 120 may obtain the serial number and initialization vector associated with the received VAC.

Voucher device 120 may look up the voucher using the serial number (block 840). For example, voucher device 120 may use the serial number to look up the corresponding voucher in batch table 410 (e.g., by comparing the serial number to the serial numbers in first serial number fields 418 of batch table 410). Voucher device 120 may analyze the fields of the identified batch to identify the particular row in which the corresponding voucher is located in voucher table 430.

Once the appropriate row of voucher table 430 has been identified (i.e., the row that corresponds to the voucher being redeemed), voucher device 120 may verify the voucher using the initialization vector (block 840). For example, voucher device 120 may compare the received initialization vector to the stored initialization vector. If the received initialization vector does not match the stored initialization vector, voucher device 120 may, for example, provide a signal to a system administrator that an error occurred.

If the received initialization vector matches the stored initialization vector, voucher device 120 may mark the voucher as used (block 845). For example, voucher device 120 may change the state of the voucher in current state field 434 in voucher table 430 to “used.” In one embodiment, voucher device 120 may also add an entry in history table 440 that reflects the change in status of the voucher, the date and/or time that the change occurred, etc.

FIG. 8C is a flowchart of an exemplary process for interacting with voucher database 400 of FIG. 4 when a subscriber update is unsuccessful. In one embodiment, the process described in FIG. 8C may be performed by voucher device 120 (e.g., by voucher redemption component 330). In another embodiment, some or all of the exemplary process described below may be performed by another device or combination of devices, including or excluding voucher device 120.

The exemplary process may begin with voucher device 120 receiving a VAC (block 850). For example, voucher device 120 may receive the VAC and an indication from the device that performed the subscriber account update of whether the update has succeeded. For this particular flowchart, assume that voucher device 120 receives an indication that the update was unsuccessful.

Voucher device 120 may process the VAC, using a decryption operation, to retrieve a serial number and an initialization vector (block 855). For example, voucher device 120 may process the VAC in a manner similar to the manner described above with respect to block 810 in FIG. 8A. At the end of the processing, voucher device 120 may obtain the serial number and initialization vector associated with the received VAC.

Voucher device 120 may look up the voucher using the serial number (block 860). For example, voucher device 120 may use the serial number to look up the corresponding voucher in batch table 410 (e.g., by comparing the serial number to the serial numbers in first serial number fields 418 of batch table 410). Voucher device 120 may analyze the fields of the identified batch to identify the particular row in which the corresponding voucher is located in voucher table 430.

Once the appropriate row of voucher table 430 has been identified (i.e., the row that corresponds to the voucher being redeemed), voucher device 120 may verify the voucher using the initialization vector (block 860). For example, voucher device 120 may compare the received initialization vector to the stored initialization vector. If the received initialization vector does not match the stored initialization vector, voucher device 120 may, for example, provide a signal to a system administrator that an error occurred.

If the received initialization vector matches the stored initialization vector, voucher device 120 may mark the voucher as available (block 865). For example, voucher device 120 may change the state of the voucher in current state field 434 in voucher table 430 to “available.” In one embodiment, voucher device 120 may also add an entry in history table 440 that reflects the change in status of the voucher, the date and/or time that the change occurred, etc.

The processes described above with respect to FIGS. 8A-8C may minimize the disk accesses needed for performing a refill. Assuming all the entries in batch table 410 are stored in memory, the entire refill process would consist of six accesses to the disk, out of which four may be likely to be a cache hit. Moreover, assuming a write-back cache strategy is used, this would result in close to two disk accesses per voucher refill, on average. For example, the following disk access operations may be performed for a refill:

1 Reserve—read state of the voucher in voucher table 430. This disk access operation may not be a cache hit. This step may also cause a dirty cache page to be written to disk to make room for the new cache page, causing two disk operations in total.

2 Reserve—write new entry in history table 440. This disk access operation may likely be a cache hit, as reserve requests add entries to a nearby physical location of the disk.

3 Reserve—write new state of the voucher in voucher table 430. This disk access operation may be a cache hit, as the state of the voucher was read in step 1 above.

4 Commit—read state of the voucher in voucher table 430 (to make sure the state is still marked as reserved). This disk access operation may be a cache hit, as the state of the voucher was just updated in step 3.

5 Commit—write new state of the voucher in voucher table 430. This disk access operation may be a cache hit, as the state of the voucher was just read in step 4.

6 Commit—write new state in the history entry created in step 2. This disk access operation may likely be a cache hit for the same reason as in step 2.

Thus, the disk accesses for a refill are minimized.

FIG. 9 is a flowchart of an exemplary process for processing a VAC to obtain a serial number. The process described below corresponds to blocks 810, 835, and 855 in FIGS. 8A, 8B, and 8C, respectively. In one embodiment, the process described in FIG. 9 may be performed by voucher device 120 (e.g., by voucher redemption component 330). In another embodiment, some or all of the exemplary process described below may be performed by another device or combination of devices, including or excluding voucher device 120.

Voucher device 120 may convert the received VAC to a binary form (block 910). Voucher device 120 may remove the initialization vector from the binary VAC (block 920). For example, voucher device 120 may strip the initialization vector from the front end of the binary form of the VAC to obtain an encrypted intermediate result. Voucher device 120 may decrypt the encrypted intermediate result to obtain an intermediate result (block 930). For example, voucher device 120 may use the corresponding decryption algorithm to obtain the intermediate result. Voucher device 120 may undo the obfuscation process (if any), used to hide the serial number, using the initialization vector to obtain a binary serial number (block 940). For example, voucher device 120 may XOR the intermediate result with a repeated version of the initialization vector, reverse any bit swapping that occurred using the initialization vector during the VAC calculation process, or perform another process or combination of processes to obtain a binary version of the serial number. Voucher device 120 may convert the binary versions of the initialization vector and the serial number to obtain decimal versions of the initialization vector and the serial number (block 950).

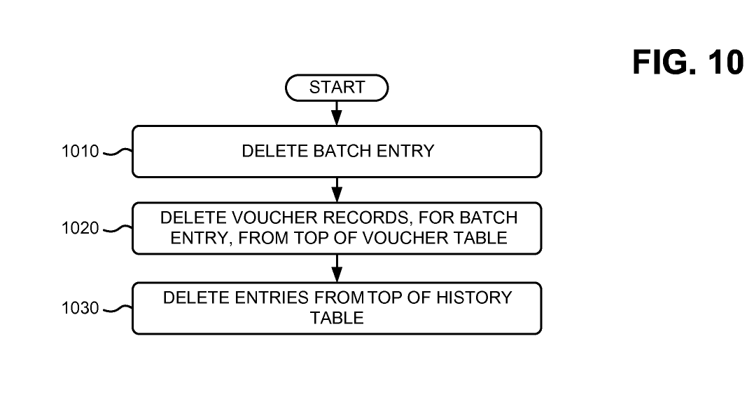

FIG. 10 is a flowchart of an exemplary process for deleting VACs from voucher database 400 of FIG. 4. In one embodiment, the process described in FIG. 10 may be performed by voucher device 120 (e.g., by voucher deletion component 340). In another embodiment, some or all of the exemplary process described below may be performed by another device or combination of devices, including or excluding voucher device 120.

Voucher device 120 may delete a batch entry from batch table 410 (block 1010). For example, voucher device 120 may receive a command that batch deletion is to be performed. The deletion may be performed automatically (e.g., at some interval) or in response to a command from a system administrator. In one embodiment, a batch of vouchers may be deleted from voucher database 400 once all the vouchers in the batch have been used and/or expired.

Voucher device 120 may delete the appropriate vouchers, for the batch entry, from voucher table 430 (block 1020). For example, voucher device 120 may delete the appropriate voucher entries at the top of voucher table 430. The deletion would include, for example, the removal of the appropriate fields (e.g., fields 432, 434, 436, and 438) for each voucher record from voucher table 430.

Voucher device 120 may delete the entries from the top of history table 440 (block 1030). For example, voucher device 120 may delete the entries at the top of history table 440. The deletion would include, for example, the removal of the appropriate fields (e.g., fields 442, 444, and 446) for each history record entry to be deleted from history table 440.

Since entries at the top of voucher table 430 and history table 440 are dropped, the process of deleting entries from voucher table 430 and history table 440 is simplified. Moreover, due to the small size of the batch table 410, the process of deleting an entry in this table may be negligible performance-wise.

The voucher device described herein provides an improved manner of managing vouchers and a manner of creating more secure VACs. For example, sequential disk access may be used for voucher insertions and deletions, which yields a high cache hit rate and good performance. In addition, by storing vouchers in the voucher database sequentially based on the serial numbers with which the vouchers are associated, there may be no need to maintain an index for the serial numbers, thereby eliminating the processing power needed to maintain the index. In fact, there is no need to store the serial numbers. Moreover, the voucher device may calculate a VAC by obfuscating (e.g., using a random number) and/or encryption the serial number to minimize the chance of malicious individuals calculating the VAC for another serial number.

Embodiments described herein provide illustration and description, but are not intended to be exhaustive or to limit the implementations to the precise form disclosed. Modifications and variations are possible in light of the above teachings, or may be acquired from practice of the implementations. For example, while series of blocks have been described with regard to FIGS. 5 and 7-10, the order of the blocks may be modified in other embodiments. Further, non-dependent blocks may be performed in parallel.

The exemplary embodiments, as described above, may be implemented in many different forms of software, firmware, and hardware in the implementations illustrated in the figures. The actual software code or specialized control hardware used to implement the exemplary embodiments described herein is not limiting of the invention. Thus, the operation and behavior of the exemplary embodiments were described without reference to the specific software code—it being understood that one would be able to design software and control hardware to implement the exemplary embodiments based on the description herein.

Further, certain portions of the invention may be implemented as “logic” that performs one or more functions. This logic may include hardware, such as an application specific integrated circuit, a field programmable gate array, a processor, or a microprocessor, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

It should be emphasized that the term “comprises/comprising” when used in the this specification is taken to specify the presence of stated features, integers, steps, or components, but does not preclude the presence or addition of one or more other features, integers, steps, components, or groups thereof.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method in a device (120) that provides refills for pre-paid subscriptions, the method comprises receiving a voucher activation code for a subscriber account, the method characterized by:
processing (810) the voucher activation code to obtain a voucher serial number, the processing including performance of a decryption operation; and
using (815) the voucher serial number to identify a voucher for use in updating the subscriber account.

2. The method of claim 1, where the processing the voucher activation code includes:
converting (910) the voucher activation code into a first binary value,
removing (920) an initialization vector from the first binary value to obtain a second binary value,
performing (930) the decryption operation on the second binary value to obtain a third binary value,
using (940) the third binary value to obtain a fourth binary value that represents the voucher serial number, and
converting (950) the fourth binary value to a decimal value to obtain the voucher serial number.

3. The method of claim 2, where the using the third binary value includes:
performing (940) an exclusive OR (XOR) operation using the third binary value and a repeating binary representation of the initialization vector.

4. The method of claim 1, where the processing the voucher activation code includes:
retrieving (810) an initialization vector, and
where the method further comprises:
using (815) the initialization vector to verify the voucher; and
updating the subscriber account when the voucher has been verified.

5. The method of claim 1, where the using includes:
retrieving the voucher from a table (430) that stores vouchers, the vouchers being stored in groups in the table, where vouchers in each group are stored sequentially by voucher serial number.

6. The method of claim 5, further comprising:
marking, in the table, the voucher as used after the subscriber account has been updated using the voucher.

7. The method of claim 1, where the device is associated with a memory (400) that stores a batch table (410) that includes information associated with batches of vouchers, and a voucher table (430) that includes vouchers, the vouchers for a batch being stored in the voucher table in a sequential order based on voucher serial numbers, and
where the using the voucher serial number includes:
accessing the batch table to identify a batch associated with the voucher serial number,
identifying a location of the voucher in the voucher table using information stored in the batch table for the identified batch, and
retrieving the voucher from the voucher table using the voucher serial number.

8. The method of claim 7, where the identifying a location of the voucher in the voucher table includes:
calculating an offset in relation to a first voucher serial number in the batch.

9. The method of claim 1, where the device is associated with a memory (400) that stores a batch table (410) that includes information associated with batches of vouchers, and a voucher table (430) that includes vouchers, and
where the method further comprises:
creating (710), prior to receiving the voucher activation code, a batch entry in the batch table for a batch of vouchers that includes the voucher, the batch of vouchers including vouchers associated with voucher serial numbers that are sequential in order;
reserving and initializing (720) a quantity of records at an end of the voucher table for the vouchers in the batch of vouchers; and
appending (730) the vouchers, in the batch of vouchers, to the end of the voucher table, the vouchers being appended in a sequential order based on voucher serial numbers associated with the vouchers.

10. The method of claim 9, where the creating the batch entry in the batch table includes:
storing, in the batch entry, information (418) identifying a first serial number of the voucher serial numbers in the batch,
storing, in the batch entry, information (420) identifying a quantity of vouchers in the batch, and
storing, in the batch entry, information (422) identifying a location in the voucher table at which the voucher corresponding to the first serial number is located.

11. A device (120) that provides refills for pre-paid subscriptions, the device being characterized by:
a memory (230, 240, 250, 400) to:
store a table (430) that includes batches of vouchers, the vouchers in each batch being sequentially ordered by serial numbers associated with the vouchers; and
a processing unit (220) to:
receive a voucher activation code associated with a subscriber account,
process the voucher activation code to obtain a serial number, the processing including performance of a decryption operation, and
retrieve a voucher from the table using the serial number to identify a voucher for use in updating the subscriber account.

12. The device of claim 11, where, when processing the voucher activation code, the processing unit is to:
convert the voucher activation code into a first binary value,
remove an initialization vector from the first binary value to obtain a second binary value,
perform the decryption operation on the second binary value to obtain a third binary value,
generate a fourth binary value, which represents the serial number, using the third binary value, and
convert the fourth binary value to a decimal value for the serial number, the decimal value being used to identify the voucher.

13. The device of claim 12, where, when generating the fourth binary value, the processing unit is to:
perform an exclusive OR (XOR) operation using the third binary value and a repeating binary representation of the initialization vector.

14. The device of claim 11, where, when processing the voucher activation code, the processing unit is to:
obtain an initialization vector, and
where the processing unit is further to:
verify the voucher using the initialization vector, and
allow for the subscriber account to be updated when the voucher has been verified.

15. The device of claim 11, where the processing unit is to:
mark, in the table, the voucher as used after the subscriber account has been updated using the voucher.

16. The device of claim 11, where the memory is further to:
store a batch table (410) that includes information associated with the batches of vouchers, and
where, when retrieving the voucher, the processing unit is to:
access the batch table to identify a batch associated with the serial number, and
identify a location of the voucher in the table using information stored in the batch table for the identified batch.

17. The device of claim 11, where the memory is further to:
store a batch table (410) that stores information associated with the batches of vouchers, and
where the processing unit is further to:
create, prior to receiving the voucher activation code, a batch entry in the batch table for a batch of vouchers that includes the voucher,
reserve and initialize a quantity of records at an end of the table for the vouchers in the batch of vouchers, and
append the vouchers, in the batch of vouchers, to the end of the table, the vouchers being appended in a sequential order based on serial numbers associated with the vouchers.

18. The device of claim 17, where, when creating the batch entry in the batch table, the processing unit is to:
store, in the batch entry, information (418) identifying a first serial number of the serial numbers in the batch,
store, in the batch entry, information (420) identifying a quantity of vouchers in the batch, and
store, in the batch entry, information (422) identifying a location in the table at which the voucher corresponding to the first serial number is located.

19. A computer-readable medium storing instructions that, when executed by a processing unit (220) of a device (120), cause the processing unit to perform a method that includes receiving a voucher activation code for a subscriber account, the method characterized by:
processing (810) the voucher activation code to obtain a voucher serial number, the processing including performance of a decryption operation;
identifying (815) a voucher in a table using the voucher serial number, the table storing vouchers in batches, where the vouchers in each batch are sequentially ordered by serial numbers associated with the vouchers; and
enabling updating (825) of the subscriber account based on the identified voucher.

20. The computer-readable medium of claim 19, where the processing the voucher activation code includes:
converting (910) the voucher activation code into a first binary value,
removing (920) an initialization vector from the first binary value to obtain a second binary value,
performing (930) the decryption operation on the second binary value to obtain a third binary value,
obtaining (940) a fourth binary value using the third binary value, the fourth binary value representing the voucher serial number, and
converting (950) the fourth binary value to a decimal value for the voucher serial number, the decimal value being used to identify the voucher.

21. The computer-readable medium of claim 20, where the obtaining the fourth binary value includes:
performing (940) an exclusive OR (XOR) operation using the third binary value and a repeating binary representation of the initialization vector.

22. The computer-readable medium of claim 19, where the processing the voucher activation code includes:
obtaining (810) an initialization vector, and
where the method further comprises:
verifying (815) the voucher using the initialization vector; and
updating the subscriber account when the voucher has been verified.

23. The computer-readable medium of claim 19, where the method further comprises:
marking, in the table, the voucher as used after the subscriber account has been updated using the voucher.

24. The computer-readable medium of claim 19, where the device is associated with a memory (400) that stores a batch table (410) that includes information associated with batches of vouchers, and
where the identifying the voucher includes:
accessing the batch table to identify a batch associated with the voucher serial number, and
identifying a location of the voucher in the table using information stored in the batch table for the identified batch.

25. The computer-readable medium of claim 24, where the identifying the location of the voucher includes:
calculating an offset from a first voucher serial number in the identified batch.

26. The computer-readable medium of claim 19, where the device is associated with a memory (400) that stores a batch table (410) that includes information associated with batches of vouchers, and
where the method further comprises:
creating (710), prior to receiving the voucher activation code, an entry in the batch table for a batch of vouchers that includes the voucher, the batch of vouchers including vouchers that include voucher serial numbers that are sequential in order;
reserving and initializing (720) a quantity of records at an end of the table for the vouchers in the batch of vouchers; and
appending (730) the vouchers, in the batch of vouchers, to the end of the table, the vouchers being appended in a sequential order based on voucher serial numbers associated with the vouchers.

27. The computer-readable medium of claim 26, where the creating the entry in the batch table includes:
storing, in the batch entry, information (418) identifying a first serial number of the voucher serial numbers in the batch,
storing, in the batch entry, information (420) identifying a quantity of vouchers in the batch, and
storing, in the batch entry, information (422) identifying a location in the voucher table at which the voucher corresponding to the first serial number is located.
